(19) United States
(12) Patent Application Publication
(10) Pub. No.: US 2019/0139168 A1
(43) Pub. Date: May 9, 2019

(54) SYSTEM AND METHODS THEREOF FOR AUTOMATED GENERATION OF AN AGREEMENT RELATED TO A PHYSICAL ASSET

(71) Applicant: Stoa Fund Ltd., Tel Aviv (IL)

(72) Inventors: Or AGASSI, Tel Aviv (IL); Tom SELLA, Miami, FL (US)

(73) Assignee: Stoa Fund Ltd., Tel Aviv (IL)

(21) Appl. No.: 16/181,966

(22) Filed: Nov. 6, 2018

Related U.S. Application Data
(60) Provisional application No. 62/581,790, filed on Nov. 6, 2017.

(51) Int. Cl. G06Q 50/16; G06F 17/30

(52) U.S. Cl. CPC G06Q 50/163; G06F 17/30283

(57) ABSTRACT

A system and method for generating an agreement related to a physical asset, including: retrieving a first set of metadata associated with a physical asset, wherein the first set of metadata is comparative metadata; retrieving a second set of metadata associated with the physical asset, wherein the second set of metadata is type metadata; and generating an agreement related to the physical asset based on the first set of metadata and the second set of metadata.

### CROSS-REFERENCE TO RELATED APPLICATIONS

This application claims the benefit of U.S. Provisional Application No. 62/581,790 filed on Nov. 6, 2017, the contents of which are hereby incorporated by reference.

### TECHNICAL FIELD

The present disclosure relates generally to agreements for physical assets, and more specifically to a system and methods thereof for automatically generating an agreement, such as a vendor agreement, related to a physical asset, such as a real-estate renovation.

### BACKGROUND

House flipping is a real estate investment strategy in which an investor purchases one or more properties with the goal of reselling them at a profit. The profit is generated either through a price appreciation that occurs as a result of a rising housing market or from developments and capital improvements made to the property itself. For example, an investor may purchase a dilapidated building at a discount, invest in repairs and upgrades, and sell at a price equal to more than the sum of the initial cost and the improvement costs. However, as with all investments, risk is a factor, and there is always a likelihood of price depreciation due to declining housing markets or other reasons, resulting in a net loss.

Investors who flips houses encounter many difficulties associated with vendor communication, especially given the stressed time frame that may often accompany such an investment. Typically, such difficulties ended in insufficient renovation and vendors' switching. Even though technology became available in most industrial areas, in the real-estate domain a massive use of manual labor to perform tedious and costly steps are executed.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating an agreement related to a physical asset, including: retrieving a first set of metadata associated with a physical asset, wherein the first set of metadata is comparative metadata; retrieving a second set of metadata associated with the physical asset, wherein the second set of metadata is type metadata; and generating an agreement related to the physical asset based on the first set of metadata and the second set of metadata.

Certain embodiments disclosed herein also include a non-transitory computer readable medium having stored thereon instructions for causing a processing circuitry to perform a process, the process including: retrieving a first set of metadata associated with a physical asset, wherein the first set of metadata is comparative metadata; retrieving a second set of metadata associated with the physical asset, wherein the second set of metadata is type metadata; and generating an agreement related to the physical asset based on the first set of metadata and the second set of metadata.

Certain embodiments disclosed herein also include a system for generating an agreement related to a physical asset, including: a processing circuitry; and a memory, the memory containing instructions that, when executed by the processing circuitry, configure the system to: retrieve a first set of metadata associated with a physical asset, wherein the first set of metadata is comparative metadata; retrieve a second set of metadata associated with the physical asset, wherein the second set of metadata is type metadata; and generate an agreement related to the physical asset based on the first set of metadata and the second set of metadata.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of an automated agreement generation system according to an embodiment.

FIG. 2 is a block diagram of the agreement generation server structured according to an embodiment.

FIG. 3 is a flowchart describing a method for generating an agreement according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

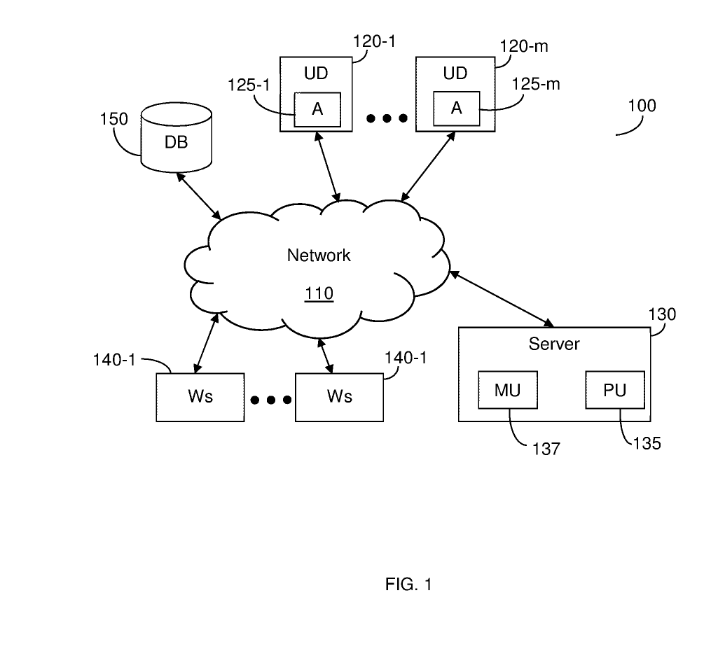

FIG. 1 is a network diagram of an automated agreement generation system 100 according to an embodiment. A network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

One or more user devices 120-1 through 120-m (where m is an integer equal to or greater than 1, hereinafter referred to individually as user device 120 and collectively as user devices 120, merely for simplicity purposes) are further connected to the network 110. A user device 120 may be, for example, a personal computer (PC), a personal digital assistant (PDA), a mobile phone, a smart phone, a tablet computer, an electronic wearable device (e.g., glasses, a watch, etc.), a smart television and other wired and mobile appliances, equipped with browsing, viewing, capturing, storing, listening, filtering, and managing capabilities enabled as further discussed herein below.

Each user device 120 may further include a software application (application or app) 125-1 through 125-m (where m is an integer equal to or greater than 1, hereinafter referred to individually as application 120 and collectively as applications 120, merely for simplicity purposes) installed thereon. The application 125 may be downloaded from an application repository, such as the AppStore®, Google Play®, or any repository hosting software applications. The application 125 may be pre-installed in the user device 120. In one embodiment, the application 125 is a web-browser.

A agreement generation server 130, or server 130, is coupled to the user device 120 and can communicate therewith using the application 125 via the network 110. The server 130 includes a processor 135 and a memory 137.

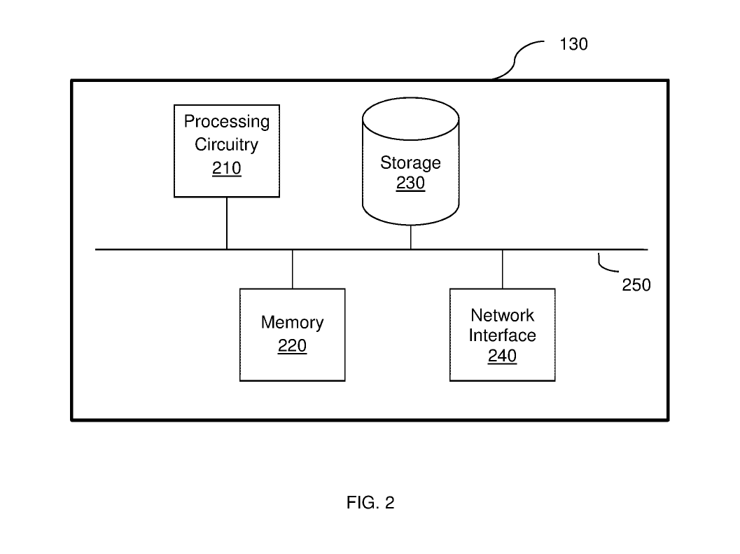

An example block diagram of the server 130 is provided below in FIG. 2. It should be noted that the server 130 may be installed on-premises or may be hosted in a cloud computing platform. The memory therein 137 contains instructions that when executed by the processor 135 configures the server 130 as further described herein. The server 130 further includes a network interface configured to connect to the network 110.

It should be noted that only one user device 120 and one application 125 are discussed herein merely for the sake of simplicity. However, the disclosed embodiments are applicable to a plurality of user devices that can communicate with the server 130 via the network 110.

The server 130 is configured to communicate via the network 110 with one or more web sources 140-1 through 140-n (where n is an integer equal to or greater than 1, hereinafter referred to individually as web source 140 and collectively as web sources 140, merely for simplicity purposes). The web sources 140 may be, for example, one or more regulatory data sources, tax or municipal authorities, geographic information systems (GISs), federal or governmental sources, and the like having information relating to a physical asset.

A data warehouse, such as a database 150 is connected to the network 110. The database includes data and metadata related to renovation projects, data extracted from web sources 140 and the like. In the embodiment illustrated in FIG. 1, the server 130 communicates with the database 150 via the network 110.

According to an embodiment, the server 130 receives a request to generate an agreement, such as a vendor agreement related to the physical asset, such as an agreement for a renovation of at least one real-estate property. The real-estate property may include, but is not limited to, residential real estate, commercial real estate, industrial real estate, and the like.

The vendor agreement is a legal agreement that states the provisions and conditions of work to be performed by a contractor or a vendor. This may include the date, time, and location where the services must be provided, the exact nature of the services, the parties to the contract, and the like. The vendor agreement further includes a statement of work (SOW), which may include timelines, deliverables, payment details, and so on. Typically, a vendor will not start to work on a project without some form of an SOW in place.

The request to generate a vendor agreement includes at least one location pointer associated with the real-estate property. The location pointer may be, for example, GIS coordinates, lot/parcel data, street address, and the like. The request may further include data associated with the real-estate owner, e.g., name, address, identification number, and so on.

Based on the at least one location pointer, a first set of metadata is retrieved, which is connected to the real-estate property. The first set of metadata is comparative metadata, and may include at least one of: parameters associated with previous transactions made with respect to one or more real-estate properties in proximity, within a predetermined threshold, to the at least one real-estate property, previous transactions made with respect to the at least one real-estate property, data regarding renovations made with respect of the real-estate property, and the like. The first set of metadata may be retrieved from an external database, for example, governmental websites via the network 110, real-estate comparison websites, such as, for example, Zillow® or Trulia®, and the like, or a combination thereof.

Thereafter, a second set of metadata, type metadata, associated with the currently planned renovation for the real-estate property is retrieved. The second set of metadata indicates a type of renovation to be completed on the property, for example, air conditioning or heating work, landscaping, plumbing, painting, construction, demolition, and the like.

The retrieval may include, for example, extraction of multimedia content elements in which the real-estate property is displayed, such as from images or videos taken by the owner or by a third party. Thereafter, the multimedia content elements are analyzed using one or more computer vision techniques, such as object classification, content-based image retrieval, and the like. Alternatively, an inspection report associated with the real-estate property may be analyzed using one or more optical character recognition techniques. According to a further embodiment, the type of renovation required may be received as an input from the user device 120.

Based on the first set of metadata and the second set of metadata, a vendor agreement is generated. In an embodiment, one of a plurality of templates is retrieved, e.g., from the database, and customized based on the first set of metadata and second set of metadata. For example, if, based on the metadata, it is determined that a renovation involving electrical work is requested, a template of a vendor agreement for electrical is retrieved from the database, and customizing information is entered into the agreement, such as party names, real-estate property location, timeline of work, and costs. The customized vendor agreement is then provided to one or more user devices 120 subsequent to the request.

FIG. 2 is an example block diagram of the agreement generation server 130 structured according to an embodiment. The server 130 includes a processing circuitry 210 connected to a memory 220, a storage 230, and a network interface 240. In an embodiment, the components of the agreement generation server 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application specific standard products (ASSPs), system-on-a-chip systems (SOCs), general purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, and the like. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to analyze the first set of metadata and the second set of metadata, and to generate a vendor agreement based thereon.

The storage 230 may be magnetic storage, optical storage, and the like, and may be realized, for example, as flash memory or other memory technology, magnetic hard drive, solid state hard drive, or any other medium which can be used to store the desired information.

The network interface 240 allows the agreement generation server 130 to communicate with the network 110, the databases 140, or a combination thereof, of FIG. 1 for the purpose of, for example, analyzing metadata and generating vendor agreements.

It should be understood that the embodiments described herein are not limited to the specific architecture illustrated in FIG. 2, and other architectures may be equally used without departing from the scope of the disclosed embodiments.

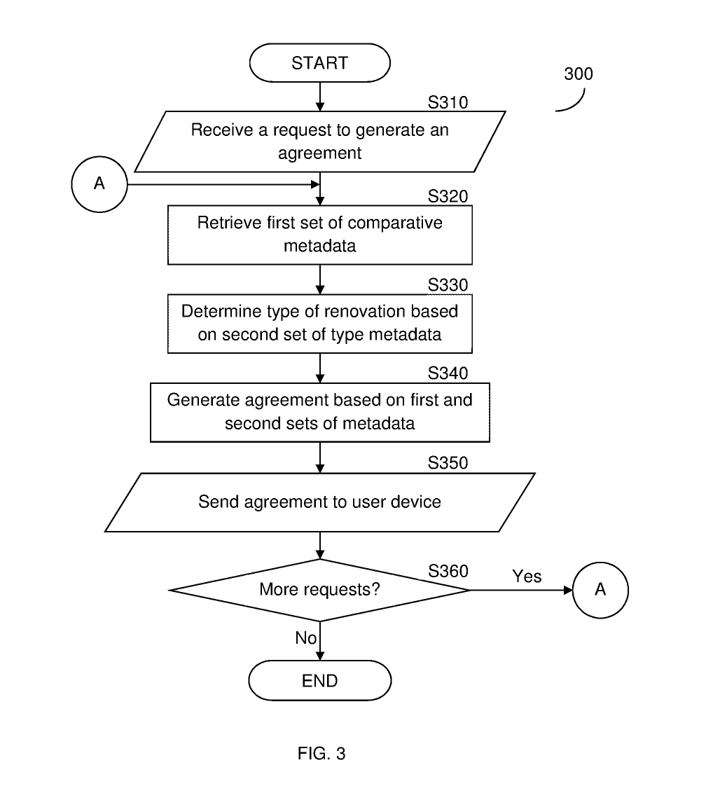

FIG. 3 is a flowchart 300 describing a method for generating an agreement according to an embodiment. At S310, the operation starts when a request to generate an agreement, such as a vendor agreement, is received. The request may be received from, for example, a user device, e.g., the user device 120 of FIG. 1, or a web source. The request includes data or metadata related to an owner of a physical asset, such as real-estate, the physical asset itself, and the like.

At S320, a first set of metadata associated with the physical asset is extracted. The first set of metadata may include at least one of: parameters associated with previous transactions made with respect to one or more real-estate properties in proximity, within a predetermined threshold, to the at least one real-estate property, previous transactions made with respect to the at least one real-estate property, data regarding renovations made with respect of the real-estate property, and the like. The first set of metadata may be extracted from, for example, governmental websites via the network 110, real-estate comparison websites, such as, for example, Zillow® or Trulia®, and the like, or a combination thereof.

The extraction may include extraction from multimedia content elements, such as from images or videos of the property. The multimedia content elements may be accessed from a database, from various web sources, and the like. Further, the multimedia content items may be input by a user, e.g., from a user device.

At S330, a second set of metadata associated with the currently planned renovation for the real-estate property is extracted. The second set of metadata indicates a type of renovation required, for example, air conditioning or heating work, landscaping, plumbing, painting, construction, demolition, and the like. According to an embodiment, the type of renovation may be determined based on an analysis of a second set of metadata, for example, multimedia content in which the real-estate property is shown. According to another embodiment, the type of renovation is determined based on an analysis of an inspection report associated with the real-estate property. The inspection report may be in an electronically readable medium or a scanned copy of a physical report, and may be accessed from a database or a web source.

At S340, an agreement, such as a vendor agreement, is generated based on the first set of metadata and the type of renovation required. The vendor agreement is to include at least the scope of work required. According to further embodiment, the vendor agreement may further include, date, time, location where the services must be provided, details associated with the real-estate owner, details associated with the vendor, and the like. S340 may further include extraction of one or more templates of vendor agreements from the database 150 determined to be appropriate for the type of renovation required.

At optional S350, the vendor agreement is sent to one or more user devices in response to the initial request. At S360, it is checked if additional requests have been received, and if so, execution continues with S320; otherwise, execution terminates.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating an agreement related to a physical asset, comprising:
retrieving a first set of metadata associated with a physical asset, wherein the first set of metadata is comparative metadata;
retrieving a second set of metadata associated with the physical asset, wherein the second set of metadata is type metadata; and
generating an agreement related to the physical asset based on the first set of metadata and the second set of metadata.

2. The method of claim 1, further comprising:
sending the generated agreement to a user device.

3. The method of claim 1, wherein the first set of metadata is retrieved from an external database.

4. The method of claim 1, wherein the agreement related to the physical asset is a vendor agreement for renovations to a real-estate property.

5. The method of claim 4, wherein the first set of metadata includes at least one of:
parameters associated with previous transactions made with respect to one or more real-estate properties in a predetermined proximity to the property; previous transactions made with respect to the real-estate property, and data regarding renovations made with respect of the real-estate property.

6. The method of claim 4, wherein the second set of metadata indicates a type of renovation to be completed on the real-estate property.

7. The method of claim 1, wherein the retrieval of at least one of the first set of metadata and the second set of metadata is retrieved from multimedia content elements displaying the physical asset.

8. The method of claim 7, wherein the multimedia content elements are analyzed using at least one computer vision techniques.

9. The method of claim 1, wherein the first set of metadata includes a location pointer associated with the physical asset.

10. The method of claim 9, wherein the location pointer includes at least one of: geographic information system (GIS) coordinates, lot or parcel data, and a property street address.

11. A non-transitory computer readable medium having stored thereon instructions for causing a processing circuitry to perform a process, the process comprising:
retrieving a first set of metadata associated with a physical asset, wherein the first set of metadata is comparative metadata;
retrieving a second set of metadata associated with the physical asset, wherein the second set of metadata is type metadata; and
generating an agreement related to the physical asset based on the first set of metadata and the second set of metadata.

12. A system for generating an agreement related to a physical asset, comprising:
a processing circuitry; and
a memory, the memory containing instructions that, when executed by the processing circuitry, configure the system to:
retrieve a first set of metadata associated with a physical asset, wherein the first set of metadata is comparative metadata;
retrieve a second set of metadata associated with the physical asset, wherein the second set of metadata is type metadata; and
generate an agreement related to the physical asset based on the first set of metadata and the second set of metadata.

13. The system of claim 12, wherein the system is further configured to:
send the generated agreement to a user device.

14. The system of claim 12, wherein the first set of metadata is retrieved from an external database.

15. The system of claim 12, wherein the agreement related to the physical asset is a vendor agreement for renovations to a real-estate property.

16. The system of claim 15, wherein the first set of metadata includes at least one of: parameters associated with previous transactions made with respect to one or more real-estate properties in a predetermined proximity to the property; previous transactions made with respect to the real-estate property, and data regarding renovations made with respect of the real-estate property.

17. The system of claim 15, wherein the second set of metadata indicates a type of renovation to be completed on the real-estate property.

18. The system of claim 12, wherein the retrieval of at least one of the first set of metadata and the second set of metadata is retrieved from multimedia content elements displaying the physical asset.

19. The system of claim 18, wherein the multimedia content elements are analyzed using at least one computer vision techniques.

20. The system of claim 12, wherein the first set of metadata includes a location pointer associated with the physical asset.

21. The system of claim 20, wherein the location pointer includes at least one of: geographic information system (GIS) coordinates, lot or parcel data, and a property street address.
